(19) United States
(12) Patent Application Publication
(10) Pub. No.: US 2012/0025596 A1
(43) Pub. Date: Feb. 2, 2012

(54) TRACTION BELT ATTACHMENT

(76) Inventor: Robert Dunham, Independence, KS (US)

(21) Appl. No.: 12/848,158

(22) Filed: Jul. 31, 2010

(51) Int. Cl. B60B 15/02; B60B 15/00

(52) U.S. Cl. 301/42; 301/41.1; 301/43

(57) ABSTRACT

A traction device for lawn equipment wheels comprising: a removable belt, where said belt is placed over the circumference of the wheel; a pin, where said pin secures the belt around the wheel; and a traction surface across the surface of the belt. The traction surface may include a plurality of chain assemblies or alternatively a plurality of pointed lugs. The pointed lugs may insert through a plurality of openings along the surface of the belt and the lugs include a pointed end and a head end.

### BACKGROUND OF THE INVENTION

1. Field of Invention

The present invention relates to a traction belt assembly that is attached to the wheel of machinery to provide additional traction in a rough terrain or during inclement weather.

2. Description of Related Art

Individuals use lawn equipment and other types of machinery that includes wheels that are used to maneuver the equipment over the surface of the lawn. The wheels supplied on most lawn equipment are usually smooth wheels and may include some type of groove traction so that the wheels traverse over the surface in a controlled manner. Traction of the wheels may be compromised in certain terrain and due to certain weather conditions such as rain or snow. Similar to automobile tires, attachment devices have been designed for the attachment to lawn equipment wheels to improve the traction thereof.

Examples of traction improvement devices include a traction device disclosed in U.S. Pat. No. 4,207,939 that discloses a traction device that is removably mounted on a vehicle tire that includes a plurality of non-formable straps of a length greater than the width arranged at evenly spaced intervals around the tread of the tire. A strap has a series of diversely running ridges on it with a pair of flexible loop nylon cords that pass through the ends of each strap. Yet another example of a traction improvement device is disclosed in U.S. Pat. No. 5,528,891 that discloses a traction control device that comprises a pair of lawn gripping assemblies. A facility is provided for mounting each non-gripping assembly onto the side of each rear wheel of the lawnmower to prevent the lawnmower from sliding down a steep slope grade.

Consequently the need for traction control when operating lawn machinery is apparently obvious. Further improvement of the traction devices are necessary to provide more suitable control devices for lawn machinery.

### SUMMARY OF THE INVENTION

The present invention relates to a traction device for lawn equipment wheels comprising: a removable belt, where said belt is placed over the circumference of the wheel; a pin, where said pin secures the belt around the wheel; and a fraction surface across the surface of the belt. The traction surface may include a plurality of chain assemblies or alternatively a plurality of pointed lugs. The pointed lugs may insert through a plurality of openings along the surface of the belt and the lugs include a pointed end and a head end.

### BRIEF DESCRIPTION OF DRAWINGS

FIG. 1A depicts an exemplary embodiment of the belt assembly according to the present invention.

FIG. 1B depicts an alternative embodiment of the traction belt according to the present invention.

FIG. 1C depicts the reverse side of the traction belt depicted in FIG. 1B.

FIG. 1D depicts openings in a section of the traction belt for the insertion of lugs according to the present invention.

FIG. 2 depicts the placement of the traction belt onto a wheel according to the present invention.

FIG. 3 depicts an alternative embodiment of the traction belt as applied to a wheel.

### DETAILED DESCRIPTION

The present invention relates to a traction belt that is easily placed onto the wheel of lawn equipment to improve the traction of the lawn equipment across a surface. The traction belt according to the present invention comes in alternative embodiments that may include chain links or pointed lugs that are placed into a traction belt that is secured onto a wheel of lawn equipment. The traction belt may be placed onto the tires after the tires have been deflated and then secured into place by inflating the tires to a firm position.

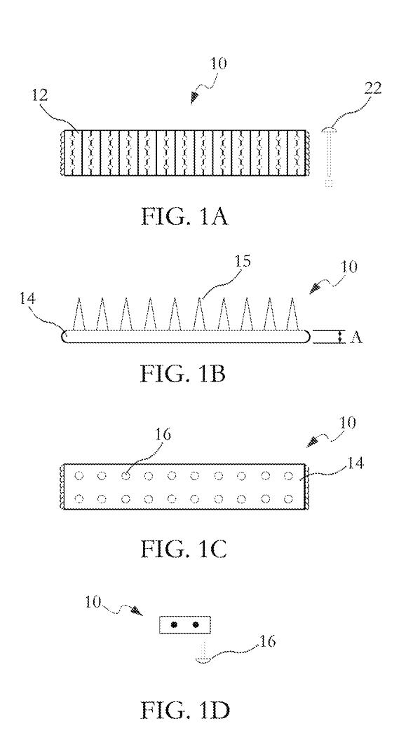

In reference to FIG. 1A, a first embodiment of a traction belt 10 according to the present invention is depicted. The traction belt 10 includes a chain tread 12 or a series of chain assemblies 11a, 11b are positioned along the left of the traction belt. The chain assemblies provide a means to improve traction of the lawn equipment during use. The traction belt is placed around a wheel through the use of a pin 22 shown adjacent to the traction belt 10. An opening is provided for the insertion of the pin which joins the belt and secures the belt around the circumference of a wheel.

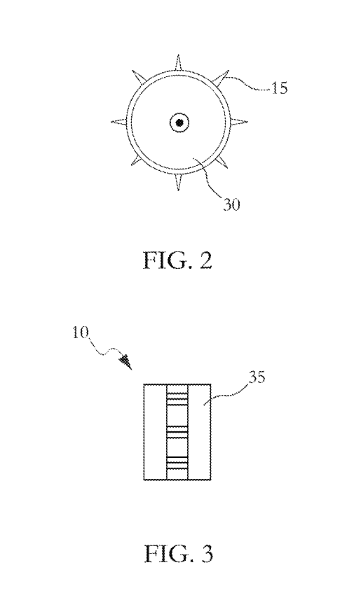

FIG. 1B depicts an alternative embodiment of the traction belt 10. The fraction belt 10 as depicted in FIG. 1B includes a plurality of point lugs 15 that are inserted through openings in a belt base 14. Once these lugs 15 are placed into the openings of the belt base 14, the belt 10 is wrapped around the wheel of lawn machinery and provides a series of cleat-like lugs that extent from the belt base 14. FIG. 2 depicts the insertion of the embodiment of FIG. 1B over a wheel 30. As is shown the wheel 30 has a series of the pointed lugs across the circumference of the wheel 30 and therefore provides firm traction control when moving lawn equipment.

FIG. 1C depicts the reverse side of the belt base 14 where lug heads 16 are shown inserted through openings along the belt base 14. Openings are depicted in a sectional view of FIG. 1D. As shown the lug 16 is inserted through the opening in the sectional view of the belt 10. Once inserted the lug 16 is secured onto the belt base and may have pointed ends as shown in FIG. 1B. Use of the traction belt and according to the present invention increases the traction capabilities of a lawn machine while being traversed over a surface. The use of the traction device is especially useful when operating in inclement conditions or over a rough terrain.

FIG. 3 shows the placement of the traction belt 10 over a wheel 35. This view of FIG. 3 shows how the belt 10 extends across a portion of the surface of the wheel 35 in order to improve the traction of the wheel. Use of a traction belt according to the present invention increases the traction available to the lawn equipment. In one particular embodiment, the air of the tire is released to allow for the insertion of the traction belt over the circumference of the tire. Once inserted the wheel is inflated and secures the traction belt in place for use. The height of the base 14 in one exemplary embodiment may be about ¼ inch where the belt is up to 6 inches in width. The various dimensions may be adjusted to accommodate for various sizes of wheels. In addition to the lawn equipment, the traction belt can also be used on all terrain vehicles in order to assist in movement across rough or sandy terrain. The instant invention has been shown and described in what it considers to be the most practical and preferred embodiments. It is recognized, however, that departures may be made there from within the scope of the invention and that obvious modifications will occur to a person skilled in the art.

What is claimed is:

1. A traction device for lawn equipment wheels comprising:
a. a removable belt, where said belt is placed over the circumference of the wheel;
b. a pin, where said pin secures the belt around the wheel; and
c. a traction surface across the surface of the belt.

2. The traction device according to claim 1, where said traction surface includes a plurality of chain assemblies.

3. The traction device according to claim 1, where said traction surface includes a plurality of pointed lugs.

4. The traction device according to claim 3, where the pointed lugs insert through a plurality of openings along the surface of the belt and said lugs include a pointed end and a head end.
